(19) United States
(12) Patent Application Publication
(10) Pub. No.: US 2025/0357058 A1
(43) Pub. Date: Nov. 20, 2025

(54) AIR CIRCUIT BREAKER

(71) Applicant: LS ELECTRIC CO., LTD., Anyang-si, Gyeonggi-do (KR)

(72) Inventor: Sangchul LEE, Anyang-si, Gyeonggi-do (KR)

(21) Appl. No.: 18/291,853

(22) PCT Filed: Sep. 8, 2022
(86) PCT No.: PCT/KR2022/013557

§ 371 Date: Dec. 18, 2024

(30) Foreign Application Priority Data
Sep. 16, 2021 (KR) 10-2021-0123791

(51) Int. Cl. H01H 9/02

(52) U.S. Cl. CPC H01H 9/02; H01H 2235/01

(57) ABSTRACT

An air circuit breaker according to an embodiment of the present disclosure comprises: a body portion provided with an opening having one open side; a plurality of movers which are rotatably coupled to the body portion and inserted in the opening; and a plurality of contact springs which are accommodated in the body portion and provide the plurality of movers respectively with an elastic force, wherein the plurality of contact springs comprise a plurality of first contact springs, and a plurality of second contact springs arranged among the plurality of first contact springs. The plurality of first contact springs may provide the plurality of movers with greater elastic force as compared with the plurality of second contact springs.

### TECHNICAL FIELD

The present disclosure relates to an air circuit breaker and, more particularly, to an air circuit breaker capable of facilitating current flow and blocking using a mover.

### BACKGROUND ART

Typically, in transmission and transformation systems or on electric lines, air circuit breakers in the related art open or close apparatuses that receive electric power. In addition, in a case where safety accidents occur such as overloading or short-circuiting, the air circuit breakers in the related art protect electric power systems and load apparatuses by blocking the flow of current.

This air circuit breaker in the related art includes a mover and a stationary element that comes into contact with the mover. In a case where the mover is in contact with the stationary element, current flows through an electric line. In a case where a safety accident causes a large current to flow through the electric line, the mover is separated from the stationary element, thereby blocking current from flowing through the electric line.

In recent years, with the increase in the electric capacity of the electric power system, air circuit breakers have been required to handle the flow of larger currents.

However, in a case where a large current flows through the air circuit breaker, an electric repulsive force is generated at a contact surface of the mover that is in contact with the stationary element, thereby causing the mover to deviate from the stationary element. Consequently, a problem arises in that it becomes necessary to unintentionally block the current from flowing through the electric line.

In a case where a strong force is exerted on the mover to address this problem, this causes the problem of decreasing the durability of the mover.

### DISCLOSURE OF INVENTION

### Technical Problem

Therefore, to obviate those problems, an aspect of the detained description is to provide an air circuit breaker capable of stably keeping a mover in contact with a stationary element when current flows through an electric line.

The present disclosure is not limited to the above-mentioned object. Other objects not mentioned would be apparent from the following description to a person of ordinary skill in the art.

### Solution to Problem

To achieve these and other advantages and in accordance with the purpose of the present disclosure, as embodied and broadly described herein, there is provided an air circuit breaker including: a body portion having a plurality of openings, each being open at one side; a plurality of movers rotatably coupled to the body portion and inserted into the plurality of openings, respectively; and a plurality of contact springs accommodated within the body portion and exerting elastic forces to the plurality of movers, respectively, wherein the plurality of contact springs include a plurality of first contact springs and a plurality of second contact springs arranged between the plurality of first contact sprints, and the plurality of first contact springs exert greater elastic forces to the plurality of movers, respectively, than the plurality of second contact springs.

In the air circuit breaker, a plurality of accommodation portions, within which the plurality of contact springs, respectively, are accommodated, may be provided in the body portion, the plurality of accommodation portions may include a plurality of first accommodation portions accommodating the plurality of first contact springs, respectively, and a plurality of second accommodation portions accommodating the plurality of second contact springs, respectively, and the plurality of second accommodation portions may have greater lengths than the plurality of first accommodation portions.

In the air circuit breaker, the plurality of first contact springs may have the same length as the plurality of second contact springs, and the plurality of first contact springs may protrude more outward out of the body portion than the plurality of second contact springs by a difference in length between the plurality of second accommodation portions and the plurality of first accommodation portions.

In the air circuit breaker, the plurality of second accommodation portions may have lengths that increase as the plurality of second accommodation portions are arranged further away from the plurality of first accommodation portions.

In the air circuit breaker, the plurality of first contact springs may have greater lengths than the plurality of second contact spring.

In the air circuit breaker, the plurality of second contact springs may have lengths that decrease as the plurality of second contact springs are arranged further away from the plurality of first contact springs.

In the air circuit breaker, the plurality of first contact springs may have higher elastic moduli than the plurality of second contact springs.

### Advantageous Effects of Invention

In accordance with the detailed description, a plurality of contact springs exert greater elastic forces to only a plurality of movers, respectively, arranged at the outermost region, which are among a plurality of movers. Concurrently, the plurality of contact springs exert smaller elastic forces to a plurality of movers, respectively, arranged at the center region. As a result, the movers can be kept in contact with stationary elements, respectively, when current flows through an electric line, without excessive forces being exerted on all the plurality of contact springs, respectively.

In addition, the non-exertion of the excessive forces on all the plurality of movers can prevent the durability of the plurality of movers from decreasing.

### BRIEF DESCRIPTION OF DRAWINGS

FIG. 1 is a perspective view illustrating an air circuit breaker according to a first embodiment of the present disclosure.

FIG. 2 is a front view illustrating the air circuit breaker according to the first embodiment of the present disclosure.

FIG. 3 is a view schematically illustrating a state where a contact spring is accommodated within a body portion.

FIG. 4 is a view illustrating an opening in the body portion.

(a) of FIG. 5 is a view illustrating a state where a plurality of contact springs are not yet accommodated within a plurality of accommodation portions, respectively. (b) of FIG. 5 is a view where the plurality of contact springs are accommodated within the plurality of accommodation portions, respectively.

FIG. 6 is a graph showing a relative current density resulting from a plurality of movers.

FIG. 7 is a table showing amounts of flowing current resulting from the plurality of movers.

(a) of FIG. 8 is a view illustrating a state where a plurality of contact springs of an air circuit breaker according to a second embodiment of the present disclosure are not yet accommodated within a plurality of accommodation portions, respectively. (b) of FIG. 8 is a view illustrating a state where the plurality of contact springs of the air circuit breaker according to the second embodiment of the present disclosure are accommodated within the plurality of accommodation portions, respectively.

FIG. 9 is a view illustrating a plurality of contact springs of an air circuit breaker according to a third embodiment of the present disclosure.

FIG. 10 is a view illustrating one of a plurality of contact springs of an air circuit breaker according to a fourth embodiment of the present disclosure.

### MODE FOR THE INVENTION

Hereinafter, various embodiments will be described in more detail with reference to the accompanying drawings. Embodiments according to the present disclosure may be modified in various ways. Specific embodiments may be depicted in the drawings and described in detail in the detailed description. However, the specific embodiments disclosed in the accompanying drawings are only intended to facilitate understanding of the various embodiments. Accordingly, the technical idea is not limited to the specific embodiments disclosed in the accompanying drawings, and should be understood to include all equivalents or substitutes included in the technical scope of the invention.

It will be understood that although the terms first, second, etc. may be used herein to describe various elements, these elements should not be limited by these terms. These terms are generally only used to distinguish one element from another.

Terms such as “include” or “has” are used herein and should be understood that they are intended to indicate an existence of several components, functions or steps, disclosed in the specification, and it is also understood that greater or fewer components, functions, or steps may likewise be utilized. It will be understood that when an element is referred to as being “connected with” another element, the element can be connected with the another element or intervening elements may also be present. In contrast, when an element is referred to as being “directly connected with” another element, there are no intervening elements present.

Meanwhile, the term “module” or “unit” for a component used in embodiments of the present disclosure performs at least one function or operation. And, the term “module” or “unit” may perform a function or operation by hardware, software, or a combination of hardware and software. Additionally, a plurality of “modules” or a plurality of “units” excluding a “module” or “unit” that must be performed on specific hardware or performed on at least one processor may be integrated into at least one module. A singular representation may include a plural representation unless it represents a definitely different meaning from the context.

In describing the present disclosure, if a detailed explanation for a related known function or construction is considered to unnecessarily divert the gist of the present disclosure, such explanation has been omitted but would be understood by those skilled in the art.

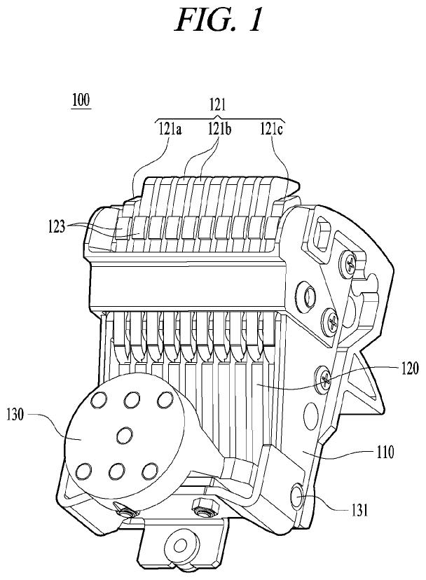

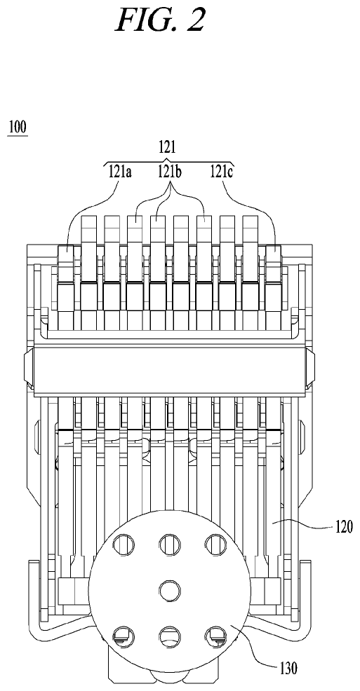

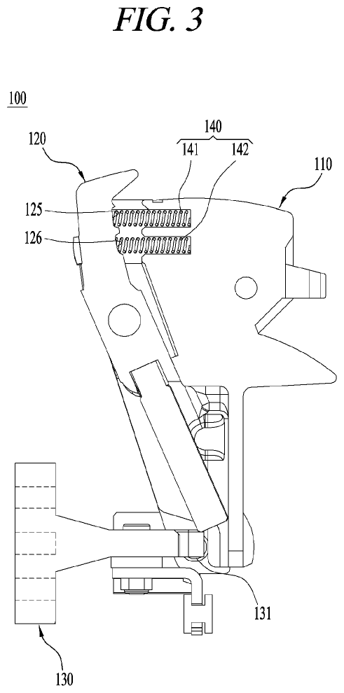

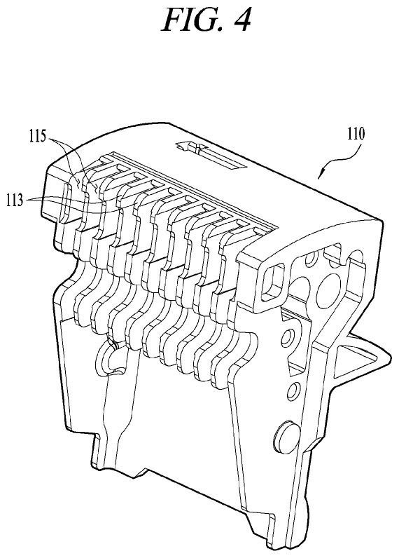

FIG. 1 is a view illustrating an air circuit breaker 100 according to a first embodiment of the present disclosure. FIG. 2 is a front view illustrating the air circuit breaker according to the first embodiment of the present disclosure. FIG. 3 is a view schematically illustrating a state where a contact spring is accommodated within a body portion. FIG. 4 is a view illustrating an opening in the body portion.

With reference to FIGS. 1 to 4, an air circuit breaker 100 according to the first embodiment of the present disclosure includes a body portion 110, a mover 120, and a plurality of contact springs 140.

The body portion 110, as illustrated in FIG. 4, has a plurality of openings 115, each being open at one side. In this case, partition portions 113 are formed on the body portion 110 in such a manner as to form the plurality of openings 115 that are separated from each other.

The mover 120 is made up of a plurality of movers 121 that are arranged to be spaced apart from each other. The plurality of movers 121 are arranged in parallel with each other. In this case, the plurality of movers 121 includes a plurality of first movers, a first mover 121a and a first mover 121c, and a plurality of second movers 121b that are arranged between the plurality of first movers, the first mover 121a and the first mover 121c.

The plurality of movers 121 are each formed of a copper (Cu) material. However, the plurality of movers 121 are each not limited to a copper material and may each be formed of various materials with electrical conductivity.

In this case, contact portions 123 are provided on the plurality of movers 121, respectively. Stationary elements (not illustrated) come into contact with the contact portions 123, respectively. The contact portions 123 are each formed of a silver (Ag) material. However, the contact portion 123 is each not limited to a silver material and may each be formed of various materials with electrical conductivity.

The plurality of movers 121 are coupled rotatably to the body portion 110. Specifically, a rotational shaft 131 is provided on a lower portion of the body portion 110, and the plurality of movers 121 are coupled to the rotational shaft 131.

Accordingly, the plurality of movers 121 are rotated about the rotational shaft 131. As a result, the plurality of movers 121 come into contact with the stationary elements (not illustrated), respectively, or deviate from the stationary elements (not illustrated), respectively.

In addition, a terminal 130, connected electrically to the mover 120, is provided on the air circuit breaker 100. Current sequentially flows through the contact portion 123, the mover 120, and the terminal 130 in this order.

The plurality of contact springs 140, as illustrated in FIG. 3, are accommodated with the body portion 110. The plurality of contact springs 140 exert elastic forces to the plurality of movers 121, respectively. In addition, each of the plurality of contact springs 140 includes an upper contact spring 141 and a lower contact spring 142 that is arranged under the contact spring 141.

Accordingly, in a case where the mover 120 comes into contact with the stationary element (not illustrated), the contact spring 140 exerts an elastic force to the mover 120 and prevents the mover 120 from deviating from the stationary element (not illustrated) due to an electrical repulsive force generated by current flow.

The plurality of contact springs 140 are described in detail below with reference to (a) and (b) of FIG. 5.

(a) of FIG. 5 is a view illustrating a state where the plurality of contact springs 140 are not yet accommodated within a plurality of accommodation portions, respectively, (b) of FIG. 5 is a view where the plurality of contact springs 140 are accommodated within the plurality of accommodation portions, respectively.

With reference to (a) and (b) of FIG. 5, each of the plurality of contact springs 141 includes a plurality of first contact springs, that is, a plurality of first contact springs 141a and a plurality of first contact springs 141c, and a plurality of second contact springs 141b.

The plurality of second contact springs 141b have the same length as the plurality of first contact springs, that is, the plurality of first contact springs 141a and the plurality of first contact springs 141c. The plurality of second contact springs 141b are arranged between the plurality of first contact springs 141a and the plurality of first contact springs 141c.

In this case, a plurality of accommodation portions, that is, a plurality of accommodation portions 115a, a plurality of accommodation portions 115b, and a plurality of accommodation portions 115c are provided in the body portion 110. The plurality of contact springs 141 are accommodated within the plurality of accommodation portions, respectively.

The plurality of accommodation portions include a plurality of first accommodation portions, that is, a plurality of first accommodation portions 115a and a plurality of first accommodation portions 115c, and a plurality of second accommodation portions 115b.

The plurality of first accommodation portions 115a accommodate the plurality of first contact springs 141a, respectively. Likewise, the plurality of first accommodation portions 115c accommodate the plurality of first contact springs 141c, respectively. In this case, the plurality of first contact springs 141a and the plurality of first contact springs 141c have greater lengths than the plurality of first accommodation portions 115a. Accordingly, in a state where the plurality of first contact springs 141a are accommodated within the plurality of first accommodation portions 115a, respectively, the plurality of first contact springs 141a protrude outward out of the body portion 110. Likewise, in a state where the plurality of first contact springs 141c are accommodated within the plurality of first accommodation portions 115c, respectively, the plurality of first contact springs 141c protrude outward out of the body portion 110.

The plurality of first contact springs 141a come into contact with the plurality of first movers 121a (refer to FIG. 1), respectively, thereby exerting elastic forces thereto, respectively. Likewise, the plurality of first contact springs 141c come into contact with the plurality of first movers 121c (refer to FIG. 1), respectively, thereby exerting elastic forces thereto, respectively.

The plurality of second accommodation portions 115b accommodate the plurality of second contact springs 141b, respectively. In this case, the plurality of second contact springs 141b have greater lengths than the plurality of second accommodation portions 115b. Accordingly, in a state where the plurality of second contact springs 141b are accommodated within the plurality of second accommodation portions 115b, respectively, the plurality of second contact springs 141b protrude outward out of the body portion 110.

The plurality of second contact springs 141b come into contact with the plurality of second movers 121b (refer to FIG. 1), respectively, thereby exerting elastic forces thereto.

In this case, the plurality of second accommodation portion 115b have greater lengths than the plurality of first accommodation portions 115a and the plurality of first accommodation portions 115c. The plurality of first contact springs 141a, as illustrated in FIG. 5(b), protrude more outward out of the body portion 110 than the plurality of second contact springs 141b, respectively, by a difference G in length between the plurality of second accommodation portions 115b and the plurality of first accommodation portions 115a. Likewise, the plurality of first contact springs 141c, as illustrated in FIG. 5(b), protrude more outward out of the body portion 110 than the plurality of second contact springs 141b, respectively, by the difference G in length between the plurality of second accommodation portions 115b and the plurality of first accommodation portions 115c.

Accordingly, the plurality of first contact springs 141a exert greater elastic forces to the plurality of movers 121 (refer to FIG. 1), respectively, than the second contact springs 141b. Likewise, the plurality of first contact springs 141c exert greater elastic forces to the plurality of movers 121 (refer to FIG. 1), respectively, than the second contact springs 141b.

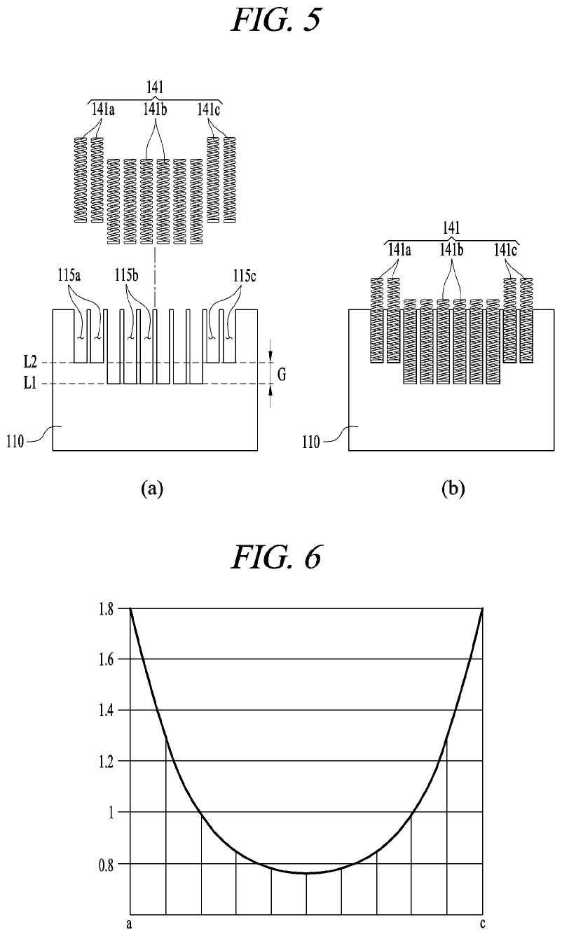

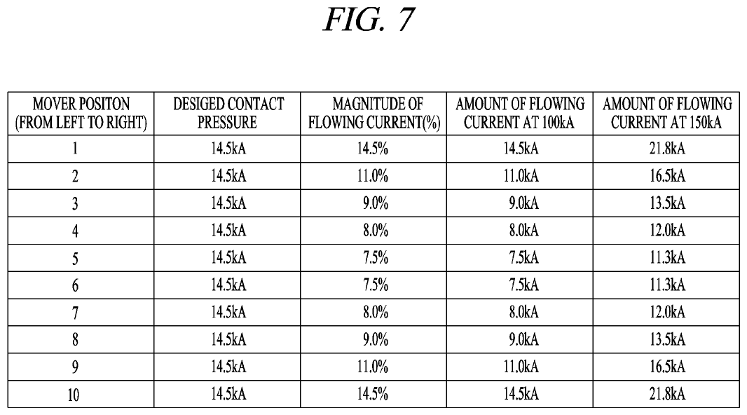

FIG. 6 is a graph showing a relative current density resulting from the plurality of movers. FIG. 7 is a table showing amounts of flowing current resulting from the plurality of movers.

First, as illustrated in FIG. 6, the X-axis represents the plurality of movers 121 (refer to FIG. 1). For example, the leftmost point a on the X-axis indicates the plurality of first movers 121a, and the rightmost point c on the X-axis indicates the plurality of first movers 121c. The Y-axis represents a relative current density of current flowing through the plurality of movers 121.

From FIG. 6, it can be seen that the plurality of movers 121 has a relative current density that decreases toward the center region, starting from the outermost regions.

As illustrated in FIG. 7, mover positions sequentially indicate the plurality of movers 121 from the leftmost point to the rightmost point, respectively. For example, mover position 1 indicates the plurality of first movers 121a (refer to FIG. 1) arranged at the leftmost point, and mover position 10 indicates the plurality of first movers 121c arranged at the rightmost point. Mover positions 2 to 9 indicate the plurality of second movers 121b, respectively.

From FIG. 7, it can be seen that current flowing through the plurality of first movers 121a and current flowing through the first movers 121c have a greater magnitude than current flowing through the plurality of second movers 121b.

In addition, it can be seen that when an amount of flowing current increases from 100 kA to 150 kA, the plurality of first movers 121a and the plurality of movers 121c experience a greater increase in magnitude of flowing current than the plurality of second movers 121b.

That is, it can be seen that the plurality of first movers 121a and the plurality of first movers 121c have greater magnitudes of flowing current than the plurality of second movers 121b. Therefore, due to electrical repulsive forces, the plurality of first movers 121a and the plurality of first movers 121c experience stronger tendencies to deviate from the stationary elements (not illustrated), respectively, than the plurality of second movers 121b.

That is, the plurality of first contact springs 141a (refer to FIG. 5) and the plurality of first contact springs 141c (refer to FIG. 5) exert greater elastic forces to the plurality of movers 121, respectively, than the plurality of second contact springs 141b (refer to FIG. 5), thereby preventing the plurality of first movers 121a and the plurality of first movers 121c from deviating from the stationary elements (not illustrated), respectively.

In addition, the plurality of second movers 121b are not much more pressed by the plurality of second contact springs 141b, respectively, than is necessary, thereby preventing the durability of the plurality of movers 121 from decreasing.

(a) of FIG. 8 is a view illustrating a state where a plurality of contact springs of an air circuit breaker according to a second embodiment of the present disclosure are not yet accommodated within a plurality of accommodation portions, respectively. (b) of FIG. 8 is a view illustrating a state where the plurality of contact springs of the air circuit breaker according to the second embodiment of the present disclosure are accommodated within the plurality of accommodation portions, respectively.

With reference to (a) and (b) of FIG. 8, the air circuit breaker according to the second embodiment of the present disclosure includes a body portion, a mover, and a plurality of contact springs. Constituent elements according to the second embodiment are not repeatedly described that are the same as or similar to the above-described constituent element according to the first embodiment. A plurality of accommodation portions 215a, 215b, 215c, 215d, 215e, 215f, 215g, 215h, 215i, and 215j according to the second embodiment are described in a focused manner.

The plurality of accommodation portions 215a, 215b, 215c, 215d, 215e, 215f, 215g, 215h, 215i, and 215j include a plurality of first accommodation portions 215a and 215j, and a plurality of second accommodation portions 215b, 215c, 215d, 215e, 215f, 215g, 215h, and 215i.

The plurality of second accommodation portions 215b, 215c, 215d, 215e, 215f, 215g, 215h, and 215i have different lengths that increase as they are arranged further away from the plurality of first accommodation portions 215a and 215j.

A plurality of contact springs 241 include a plurality of contact springs 241a, 241j, accommodated within the plurality of first accommodation portions 215a and 215j, respectively, and a plurality of second contact springs 241b, 241c, 241d, 241e, 241f, 241g, 241h, and 241i, accommodated within the plurality of second accommodation portions 215b, 215c, 215d, 215e, 215f, 215g, 215h, and 215i, respectively.

When the plurality of contact springs 241 are accommodated within the plurality of accommodation portions 215a, 215b, 215c, 215d, 215e, 215f, 215g, 215h, 215i, and 215j, respectively, protruding portions of the plurality of contact springs 241 have lengths that increase from the center outward.

That is, since the plurality of contact springs 241 are provided in such a manner that the protruding portions thereof have lengths that increase from the center outward, a plurality of movers 121 exert elastic forces that increase from the center outward.

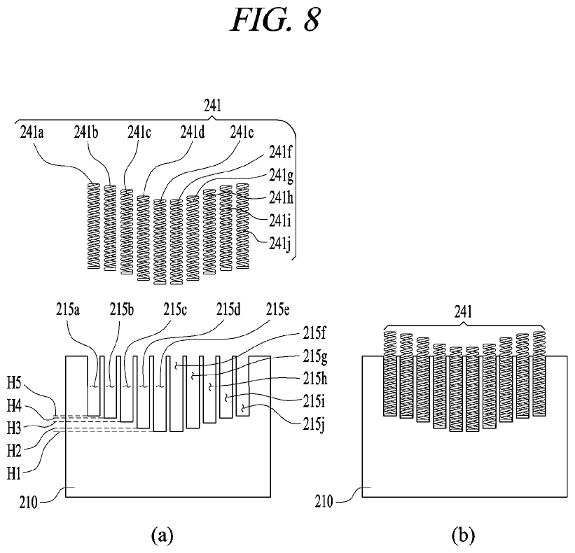

FIG. 9 is a view illustrating a plurality of contact springs of an air circuit breaker according to a third embodiment of the present disclosure.

With reference to FIG. 9, the air circuit breaker according to the third embodiment of the present disclosure includes a body portion, a mover, a plurality of contact springs. Constituent elements according to the third embodiment of the present disclosure are not repeatedly described that are the same as or similar to the above-described constituent elements according to the first embodiment. A plurality of contact springs 341 according to the third embodiment are described in a focused manner.

First, the plurality of contact springs 341 are accommodated within a plurality of accommodation portions, respectively.

In this case, the plurality of accommodation portions have the same length.

The plurality of contact springs 341 include a plurality of first contact springs 341a and 341j and a plurality of second contact springs 341b, 341c, 341d, 341e, 341f, 341g, 341h, and 341i.

In this case, the plurality of second contact springs 341b, 341c, 341d, 341e, 341f, 341g, 341h, and 341i have lengths that decrease as they are arranged further away from first contact springs 341a and 341j.

That is, when the plurality of contact springs 341 are accommodated within the plurality of accommodation portions, respectively, protruding portions of the plurality of contact springs 341 have lengths that increase from the center outward.

That is, since the plurality of contact springs 341 are provided in such a manner that the protruding portions thereof have lengths that increase from the center outward, a plurality of movers 121 exert elastic forces that increase from the center outward.

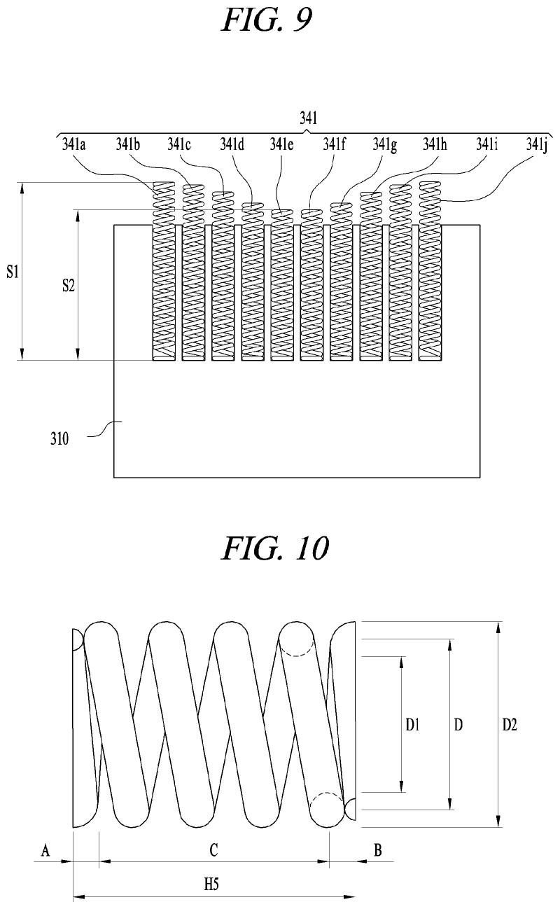

FIG. 10 a view illustrating one of a plurality of contact springs of an air circuit breaker according to a fourth embodiment of the present disclosure.

The plurality of contact springs of the air circuit breaker according to the fourth embodiment of the present disclosure have the same length. The plurality of contact springs are accommodated within a plurality of accommodation portions, respectively, and the plurality of accommodation portions have the same length.

The plurality of contact springs include a plurality of first contact springs and a plurality of second contact springs arranged between the plurality of first contact springs.

In this case, the plurality of first contact springs have higher elastic moduli than the plurality of second contact springs.

Accordingly, the plurality of first contact springs exert greater elastic forces to the plurality of movers 121, respectively, than the plurality of second contact springs.

In addition, as illustrated in FIG. 10, according to the first to fourth embodiments of the present disclosure, the plurality of first contact springs have greater wire diameters D than the plurality of second contact springs, and thus, the plurality of first contact springs have higher elastic moduli than the plurality of second contact springs.

In addition, according to the first to fourth embodiments of the present disclosure, free lengths of the plurality of first contact springs are smaller than free lengths H5 of the plurality of second contact spring, and thus the plurality of first contact spring have higher elastic moduli than the plurality of second contact springs.

In addition, according to the first to fourth embodiment of the present disclosure, mean diameters D1 of the plurality of first contact springs are smaller than mean diameters D2 of the plurality of second contact springs. The mean diameter here refers to the middle of the inner and outer diameters.

The mean diameters D1 of the plurality of first contact springs are smaller than the mean diameter D2 of the plurality of second contact springs, and thus the plurality of first contact springs have higher elastic moduli than the plurality of second contact springs.

The foregoing description has been given of preferred embodiments according to the present disclosure, and it is obvious to those skilled in the art that the present disclosure can be embodied in other specific forms in addition to the embodiments described above without departing from the scope thereof. Therefore, the above-described embodiments are to be regarded as illustrative and not restrictive, and thus the present disclosure is not limited to the above description but may be modified within the scope of the appended claims and their equivalents.

1. An air circuit breaker comprising:
a body portion having a plurality of openings, each being open at one side;
a plurality of movers rotatably coupled to the body portion and inserted into the plurality of openings, respectively; and
a plurality of contact springs accommodated within the body portion and exerting elastic forces to the plurality of movers, respectively,
wherein the plurality of contact springs include a plurality of first contact springs and a plurality of second contact springs arranged between the plurality of first contact sprints, and the plurality of first contact springs exert greater elastic forces to the plurality of movers, respectively, than the plurality of second contact springs.

2. The air circuit breaker of claim 1, wherein a plurality of accommodation portions, within which the plurality of contact springs, respectively, are accommodated, are provided in the body portion, and the plurality of accommodation portions include a plurality of first accommodation portions accommodating the plurality of first contact springs, respectively, and a plurality of second accommodation portions accommodating the plurality of second contact springs, respectively.

3. The air circuit breaker of claim 2, wherein the plurality of second accommodation portions have greater lengths than the plurality of first accommodation portions.

4. The air circuit breaker of claim 3, wherein the plurality of first contact springs have the same length as the plurality of second contact springs, and the plurality of first contact springs protrudes more outward out of the body portion than the plurality of second contact springs by a difference in length between the plurality of second accommodation portions and the plurality of first accommodation portions.

5. The air circuit breaker of claim 2, wherein the plurality of second accommodation portions have lengths that increase as the plurality of second accommodation portions are arranged further away from the plurality of first accommodation portions.

6. The air circuit breaker of claim 1, wherein the plurality of first contact springs have greater lengths than the plurality of second contact spring.

7. The air circuit breaker of claim 6, wherein the plurality of second contact springs have lengths that decrease as the plurality of second contact springs are arranged further away from the plurality of first contact springs.

8. The air circuit breaker of claim 1, wherein the plurality of first contact springs have higher elastic moduli than the plurality of second contact springs.
